(19) United States
(12) Patent Application Publication
(10) Pub. No.: US 2020/0279693 A1
(43) Pub. Date: Sep. 3, 2020

(54) DYE-SENSITIZED SOLAR CELL COMPRISING LIGHT COLLECTING DEVICE PANEL

(71) Applicant: SOGANG UNIVERSITY RESEARCH & BUSINESS DEVELOPMENT FOUNDATION, Seoul (KR)

(72) Inventors: Jun Hyuk MOON, Seoul (KR); Su Jin HA, Seoul (KR)

(21) Appl. No.: 16/098,687

(22) PCT Filed: May 4, 2017
(86) PCT No.: PCT/KR2017/004721

§ 371 Date: Nov. 2, 2018

(30) Foreign Application Priority Data
May 4, 2016 (KR) 10-2016-0055344

(51) Int. Cl. H01G 9/20; B32B 17/10; H02S 20/22; H02S 20/21

(52) U.S. Cl. CPC H01G 9/2068; B32B 17/10036; B32B 17/10669; B32B 17/1077; B32B 2457/00; H01G 9/209; H02S 20/22; H02S 20/21; B32B 2307/412; H01G 9/2059

(57) ABSTRACT

The present disclosure relates to a dye-sensitized solar cell including a light-collecting device panel disposed between a first transparent substrate and a second transparent substrate, including a polymer film containing a luminescent dye; and a frame formed in contact with a corner of the light-collecting device panel, including a photoelectrode containing a dye.

### TECHNICAL FIELD

The present disclosure relates to a dye-sensitized solar cell including a light-collecting device panel containing a luminescent dye.

### BACKGROUND

In general, a solar cell is a device that converts light energy of the sun into electric energy. The solar cell is a device that generates electricity using sunlight which is an infinite energy source. A silicon solar cell as a representative solar cell has already been widely used in our lives, and a dye-sensitized solar cell has been researched as a next-generation solar cell.

A representative example of dye-sensitized solar cells is presented by Gratzel et al. from Switzerland (refer to U.S. Pat. No. 5,350,644). In the structural aspect, one of two electrodes of the dye-sensitized solar cell is a photoelectrode including a transparent conductive substrate having thereon a semiconductor oxide layer on which a photosensitive dye is adsorbed, and an electrolyte fills a gap between the two electrodes.

The principle of the operation of the dye-sensitized solar cell is as follows. When solar energy is absorbed by the photosensitive dye adsorbed onto the semiconductor oxide layer of the photoelectrode, photoelectrons are generated. The photoelectrons are conducted through the semiconductor oxide layer and transferred to the transparent conductive substrate on which a transparent electrode is formed. The dye oxidized as a result of losing the electrons is reduced by redox pairs included in the electrolyte. Meanwhile, electrons that reach the counter electrode on the opposite side through an external electric line reduce the redox pairs of the oxidized electrolyte. In this way, the solar cell is operated.

Korean Patent Application No. 10-2014-0145257 discloses a transparent substrate having a down converting material containing a single luminescent dye and a dye solar cell module including the same. However, the disclosed solar cell does not have high photoelectric conversion efficiency.

### DISCLOSURE OF THE INVENTION

### Problems to be Solved by the Invention

The present disclosure provides a dye-sensitized solar cell including a light-collecting device panel containing a luminescent dye.

However, problems to be solved by the present disclosure are not limited to the above-described problems, and although not described herein, other problems to be solved by the present disclosure can be clearly understood by those skilled in the art from the following descriptions.

### Means for Solving the Problems

A first aspect of the present disclosure provides a dye-sensitized solar cell including the following components:

A light-collecting device panel disposed between a first transparent substrate and a second transparent substrate, including a polymer film containing a luminescent dye; and a frame formed in contact with a corner of the light-collecting device panel, including a photoelectrode containing a dye.

### Effects of the Invention

In accordance with an embodiment of the present disclosure, a dye-sensitized solar cell includes a light-collecting device panel containing a luminescent dye, and, thus, the luminescent dye absorbs and converts sunlight and emits light with a wavelength in a specific range (e.g., a visible light range). Therefore, light with a wavelength which cannot be absorbed by conventional solar cells is converted into light with a wavelength which can be absorbed by the solar cells, and, thus, when it is applied to a light-collecting device, the photoelectric conversion efficiency of the solar cell can be improved.

In general, a conventional dye-sensitized solar cell absorbs visible light and generates photoelectrons. Sunlight includes ultraviolet light and infrared light as well as visible light, and particularly, the ultraviolet light may cause deterioration in long-term performance, such as durability, of the solar cell. Further, in order to block out the ultraviolet light, when a solar cell is manufactured, a ultraviolet-proof film is used to selectively block out the ultraviolet light. However, the ultraviolet-proof film has been bad for the penetration of visible light and has caused an increase in manufacturing costs due to manufacturing of additional equipment. Therefore, in accordance with an embodiment of the present disclosure, sunlight is allowed to pass through a light-collecting device panel containing a luminescent dye before directly reaching a photoelectrode of a dye-sensitized solar cell and a wavelength of the light is converted into a wavelength in a visible light range, and, then, the light is incident on the photoelectrode. Therefore, the dye-sensitized solar cell can absorb light in a wider wavelength, which results in an increase of the photoelectric conversion efficiency and an improvement in life of the solar cell.

Further, in accordance with an embodiment of the present disclosure, a wavelength of light emitted by luminescent dyes can be regulated depending on a difference in relative luminescent properties between the luminescent dyes by appropriately regulating a mixture of the luminescent dyes. Therefore, it is easy to design dyes of various structures as needed.

In accordance with an embodiment of the present disclosure, the luminescent dye contained in the light-collecting device panel included in the dye-sensitized solar cell absorbs light incident on the light-collecting device panel and converts the light into light with a longer or shorter wavelength to emit visible light. The emitted light is totally reflected at an interface between the light-collecting device panel and air to reach the photoelectrode covering the light-collecting panel. Thus, the light can be evenly propagated to the photoelectrode in contact with the light-collecting device panel without loss of energy.

In accordance with an embodiment of the present disclosure, a cell module including the photoelectrode of the dye-sensitized solar cell has a frame shape that covers all the corners of the light-collecting device panel, and, thus, light generated by the light-collecting device panel and totally reflected can be efficiently propagated to the photoelectrode in contact with the light-collecting device panel. Particularly, photoelectrodes are disposed to be in contact with respective narrow corners of the light-collecting device panel, and, thus, light dispersed by the light-collecting device panel can be concentrated on surfaces in contact with the photoelectrodes. Therefore, the amount of light incident on a unit area can be increased.

Further, in accordance with an embodiment of the present disclosure, the light-collecting device panel and the solar cell are configured as one unit, and, thus, it is possible to provide a window-type solar cell. Further, the solar cell includes the transparent light-collecting device panel using glass or plastic, and, thus, it can be lighted. Therefore, the solar cell can be used in a building's windows and doors requiring transparency and can be variously applicable to an automobile, a ship, a roadside guard rail, or a soundproof wall as well as construction materials for house and building.

### BRIEF DESCRIPTION OF THE DRAWINGS

FIG. 1 is a schematic diagram illustrating a dye-sensitized solar cell including a light-collecting device panel in accordance with an embodiment of the present disclosure.

FIG. 2 is a photograph of a light-collecting device panel in accordance with an example of the present disclosure.

FIG. 3A and FIG. 3B are photographs of a dye-sensitized solar cell including a light-collecting device panel in accordance with an example of the present disclosure.

FIG. 4 is a graph showing current-voltage relationship measured from a dye-sensitized solar cell in accordance with an example of the present disclosure.

FIG. 5 provides a photograph (FIG. 5A) of a dye-sensitized solar cell including a light-collecting device panel and a graph (FIG. 5B) showing current-voltage relationship measured from the dye-sensitized solar cell in accordance with an example of the present disclosure.

FIG. 6A and FIG. 6B are graphs showing the measured luminescence intensities depending on the kind and concentration of a luminescent dye in accordance with an example of the present disclosure.

### BEST MODE FOR CARRYING OUT THE INVENTION

Hereinafter, embodiments and examples of the present disclosure will be described in detail with reference to the accompanying drawings so that the present disclosure may be readily implemented by those skilled in the art. However, it is to be noted that the present disclosure is not limited to the embodiments and examples but can be embodied in various other ways. In drawings, parts irrelevant to the description are omitted for the simplicity of explanation, and like reference numerals denote like parts through the whole document.

Through the whole document, the term “connected to” or “coupled to” that is used to designate a connection or coupling of one element to another element includes both a case that an element is “directly connected or coupled to” another element and a case that an element is “electronically connected or coupled to” another element via still another element.

Through the whole document, the term “on” that is used to designate a position of one element with respect to another element includes both a case that the one element is adjacent to the another element and a case that any other element exists between these two elements.

Further, through the whole document, the term “comprises or includes” and/or “comprising or including” used in the document means that one or more other components, steps, operation and/or existence or addition of elements are not excluded in addition to the described components, steps, operation and/or elements unless context dictates otherwise.

Through the whole document, the term “about or approximately” or “substantially” are intended to have meanings close to numerical values or ranges specified with an allowable error and intended to prevent accurate or absolute numerical values disclosed for understanding of the present disclosure from being illegally or unfairly used by any unconscionable third party.

Through the whole document, the term “step of” does not mean “step for”.

Through the whole document, the term “combination(s) of” included in Markush type description means mixture or combination of one or more components, steps, operations and/or elements selected from a group consisting of components, steps, operation and/or elements described in Markush type and thereby means that the disclosure includes one or more components, steps, operations and/or elements selected from the Markush group.

A first aspect of the present disclosure provides a dye-sensitized solar cell including the following components:

A light-collecting device panel disposed between a first transparent substrate and a second transparent substrate, including a polymer film containing a luminescent dye; and a frame formed in contact with a corner of the light-collecting device panel, including a photoelectrode containing a dye.

In an embodiment of the present disclosure, the first transparent substrate and the second transparent substrate may each independently include a glass or a transparent polymer, but may not be limited thereto.

In an embodiment of the present disclosure, the luminescent dye included in the polymer film may include a luminescent dye selected from the group consisting of anthracene-based luminescent dyes, pyrene-based luminescent dyes, perylene-based luminescent dyes, fluorine-based luminescent dyes, and combinations thereof; or selected from the group consisting of porphyrin-based luminescent dyes, benzoporphyrin-based luminescent dyes, metal-phthalocyanine-based luminescent dyes, polyimine-based luminescent dyes, and combinations thereof, but may not be limited thereto.

In an embodiment of the present disclosure, the luminescent dye may convert a wavelength of light incident on the light-collecting device panel to emit light. For example, the luminescent dye may convert a wavelength of light incident on the light-collecting device panel to emit light with a wavelength in a visible light range, and the emitted light in the visible light range may be propagated to the photoelectrode and absorbed by the dye contained in the photoelectrode, and, thus, light absorption of the dye-sensitized solar cell can be improved, which can result in an improvement in the efficiency of the solar cell.

In an embodiment of the present disclosure, the luminescent dye may be dispersed in a matrix of the polymer film, but may not be limited thereto.

In an embodiment of the present disclosure, the luminescent dye contained in the polymer film may include one, or two or more different luminescent dyes, but may not be limited thereto.

The luminescent dye contained in the polymer film may be appropriately selected by those skilled in the art from luminescent dyes known in the art and may have wavelength conversion properties caused by up-conversion or down-conversion. For example, if the luminescent dye contained in the polymer film has down-conversion properties, the luminescent dye may absorb ultraviolet light and emit light in a visible light range through down-conversion or absorb light having a wavelength in a visible light range (e.g., from about 400 nm to 500 nm) and emit light having a longer wavelength (e.g., from about 500 nm to about 650 nm) through down-conversion; and if the luminescent dye contained in the polymer film has up-conversion properties, the luminescent dye may absorb infrared light (absorb two photons) and emit light (one photon) in a visible light range through up-conversion or absorb light (absorb two photons) having a wavelength of from about 500 nm to 650 nm and emit light (one photon) having a wavelength of from about 400 nm to about 500 nm through up-conversion, but may not be limited thereto. In this case, the luminescent down-conversion dye may include a luminescent dye selected from the group consisting of anthracene-based luminescent dyes, pyrene-based luminescent dyes, perylene-based luminescent dyes, fluorine-based luminescent dyes, and combinations thereof, and the luminescent up-conversion dye may include a luminescent dye selected from the group consisting of porphyrin-based luminescent dyes, benzoporphyrin-based luminescent dyes, metal-phthalocyanine-based luminescent dyes, polyimine-based luminescent dyes, and combinations thereof, but may not be limited thereto.

In another embodiment of the present disclosure, if the luminescent dye contained in the polymer film includes one luminescent dye, the luminescent dye performs down-conversion.

In yet another embodiment of the present disclosure, the luminescent dye contained in the polymer film includes two or more different luminescent dyes. In this case, each of the two or more different luminescent dyes may have wavelength conversion properties caused by up-conversion or down-conversion. For example, if the luminescent dye contained in the polymer film includes a first luminescent dye and a second luminescent dye, one of the two luminescent dyes may function as a light-absorbing dye and the other one of the two luminescent dyes may function as a wavelength conversion (up-conversion or down-conversion) dye. For example, the first luminescent dye may include a dye that has down-conversion properties and absorbs ultraviolet light and emits light in a visible light range through wavelength conversion or absorbs light having a wavelength in a visible light range (e.g., from about 400 nm to 500 nm) and emits light having a longer wavelength (e.g., from about 500 nm to about 650 nm), and the second luminescent dye may include a dye that absorbs light in an infrared light (absorbs two photons), transfers energy of the absorbed light to the first luminescent dye and emits light (one photon) in a visible light range through wavelength conversion of the first luminescent dye or the second luminescent dye may include a dye that absorbs light (absorbs two photons) having a wavelength of from about 500 nm to 650 nm, transfers energy of the absorbed light to the first luminescent dye and emits light (one photon) having a wavelength of from about 400 nm to about 500 nm through wavelength conversion of the first luminescent dye, but may not be limited thereto. In this case, the first luminescent dye may include a luminescent dye selected from the group consisting of anthracene-based luminescent dyes, pyrene-based luminescent dyes, perylene-based luminescent dyes, fluorine-based luminescent dyes, and combinations thereof, and the second luminescent dye may include a luminescent dye selected from the group consisting of porphyrin-based luminescent dyes, benzoporphyrin-based luminescent dyes, metal-phthalocyanine-based luminescent dyes, polyimine-based luminescent dyes, and combinations thereof, but may not be limited thereto.

As described above, if the luminescent dye includes two luminescent dyes, the luminescence intensity can be regulated by controlling a ratio of the luminescent dyes. A molar ratio of the luminescent dye that absorbs light to the luminescent dye that converts a wavelength may be controlled to, for example, from about 1:100 to about 1:10, but may not be limited thereto.

In an embodiment of the present disclosure, the polymer film may include ethylene vinyl acetate (EVA), polyvinyl alcohol (PVA), polyvinyl chlorides (PVC), polyethylene terephthalates (PET), polyacrylates, polymethylmethacrylates (PMMA), polyurethanes, polycarbonates, polyethylenes, polypropylenes, polysiloxanes, cellulose acetate butyrates (CAB), polyisocyanates, polypropyleneoxides, hydroxyethyl acrylates, hydroxyethyl methacrylates, propyleneoxide monoacrylates, rubber-based compounds, or copolymers thereof, but may not be limited thereto. The polymer film may be transparent or may be transparent and flexible, but may not be limited thereto.

In an embodiment of the present disclosure, a light emitted by the luminescent dye contained in the light-collecting device panel is totally reflected at an interface between the light-collecting device panel and air to be collected at the corner of the light-collecting device panel, but may not be limited thereto.

In an embodiment of the present disclosure, the photoelectrode may include an oxide of a transition metal selected from the group consisting of Ti, Cu, Zr, Sr, Zn, In, Ir, La, V, Mo, W, Sn, Nb, Y, Sc, Sm, Ga, and combinations thereof, but may not be limited thereto.

In an embodiment of the present disclosure; the frame may be a window frame shape having four corners, and the photoelectrodes may be formed at the respective four corners in inner sides in contact with the light-collecting device panel, but may not be limited thereto.

In an embodiment of the present disclosure, the dye-sensitized solar cell may be a window-type solar cell, but may not be limited thereto.

In an embodiment of the present disclosure, the dye-sensitized solar cell may be installed in a house, a building, an automobile, a ship, a roadside guard rail, or a soundproof wall, but may not be limited thereto.

In an embodiment of the present disclosure, the light-collecting device panel contains the luminescent dye, and, thus, the luminescent dye absorbs and converts sunlight and emits light with a wavelength in a specific range. Therefore, light with a wavelength which cannot be absorbed by conventional solar cells is converted into light with a wavelength which can be absorbed by the solar cells, and, thus, when it is applied to a light-collecting device, the photoelectric conversion efficiency of the solar cell can be improved.

In an embodiment of the present disclosure, the luminescent dye contained in the light-collecting device panel absorbs and emits light, and the emitted light is totally reflected at an interface of the light-collecting device panel to concentrate and reach the photoelectrode covering the corners of the light-collecting device panel. Thus, the light can be efficiently propagated to the photoelectrode.

In an embodiment of the present disclosure, the light-collecting device panel and a frame including a photoelectrode, an electrolyte, and a counter electrode are configured as one unit, and, thus, it is possible to provide a window-type solar cell. Further, the solar cell includes a transparent light-collecting device panel using glass or a transparent polymer. Therefore, it can be used in a building's windows and doors and can be variously applicable to an automobile, a ship, a roadside guard rail, or a soundproof wall as well as construction materials for house and building.

Hereinafter, embodiments and examples of the present disclosure will be described in detail with reference to the accompanying drawings.

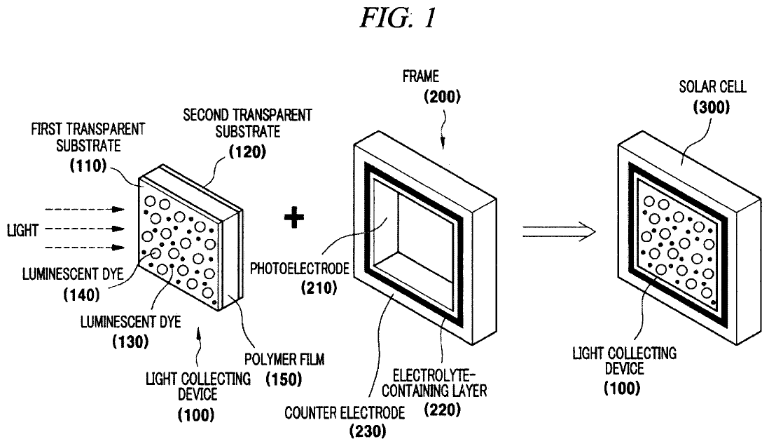

FIG. 1 is a schematic diagram illustrating a dye-sensitized solar cell including a light-collecting device panel 100 in accordance with an embodiment of the present disclosure. The dye-sensitized solar cell according to an embodiment of the present disclosure illustrated in FIG. 1 may include a light-collecting device panel 100 disposed between a first transparent substrate 110 and a second transparent substrate 120, including a polymer film 150 containing luminescent dyes 130 and 140; and a frame 200 formed in contact with a corner of the light-collecting device panel 100, including a photoelectrode 210 containing a dye, but may not be limited thereto.

In an embodiment of the present disclosure, the first transparent substrate 110 and the second transparent substrate 120 may include a glass or a transparent polymer, but may not be limited thereto. The first transparent substrate 110 and the second transparent substrate 120 may be formed using any material having transparency that allows the incidence of external light without particular limitation. For example, the first transparent substrate 110 and the second transparent substrate 120 may be formed using a glass substrate or a transparent polymer substrate having flexibility. A material of the transparent polymer substrate which can be used for the transparent substrate may include, for example, polypropylene (PP), polyimide (PI), polyethylene terephthalate (PET), polyethylene naphthalate (PEN), polycarbonate (PC), triacetyl cellulose (TAC), or copolymers thereof, but may not be limited thereto. The first transparent substrate 110 and the second transparent substrate 120 can provide sufficient transparency for incident light to reach the polymer film 150 containing the luminescent dyes 130 and 140. In the present specification, the term “transparent” refers to not only the case where a material has a light transmittance of 100% but also the case where a material has a high light transmittance.

In an embodiment of the present disclosure, the first transparent substrate 110 and the second transparent substrate 120 may be formed by sequentially bonding the first transparent substrate 110, the polymer film 150 containing the luminescent dyes 130 and 140, and the second transparent substrate 120 or installing the first transparent substrate 110 and the second transparent substrate 120 and injecting the polymer film 150 containing the luminescent dyes 130 and 140 to have a sandwich structure in which the polymer film 150 containing the amorphous or flowable luminescent dyes 130 and 140 is located in the middle, but may not be limited thereto. Further, the first transparent substrate 110 and the second transparent substrate 120 may be provided as partition walls facing each other and encapsulated. Furthermore, the first transparent substrate 110 and the second transparent substrate 120 may be disposed with a predetermined distance therebetween, and, thus, the light-collecting device panel 100 can maintain its shape and have a predetermined thickness.

In an embodiment of the present disclosure, the first transparent substrate 110 and the second transparent substrate 120 may have transparency that facilitates the incidence of external light, and light emitted from the polymer film 150 containing the luminescent dyes 130 and 140 may have a predetermined refractive index to be totally reflected at an interface between the first and second transparent substrates 110 and 120 and air, but may not be limited thereto.

In an embodiment of the present disclosure, the luminescent dyes 130 and 140 contained in the polymer film 150 may include a first luminescent dye selected from the group consisting of anthracene-based luminescent dyes, pyrene-based luminescent dyes, perylene-based luminescent dyes, fluorine-based luminescent dyes, and combinations thereof; and/or a second luminescent dye selected from the group consisting of porphyrin-based luminescent dyes, benzoporphyrin-based luminescent dyes, metal-phthalocyanine-based luminescent dyes, polyimine-based luminescent dyes, and combinations thereof, but may not be limited thereto.

In an embodiment of the present disclosure, the luminescent dyes 130 and 140 contained in the polymer film 150 may include one, or two or more different luminescent dyes, but may not be limited thereto.

Further, in order to achieve light emission with a combination of two luminescent dyes through up-conversion, a combination of quantum dot-organic dye such as quantum dot (for non-limiting example, CdS, PbS, etc.)/Rubrene or inorganic up-conversion particles such as NaYF₄:Yb and Tm may be used, but the present disclosure may not be limited thereto.

In an embodiment of the present disclosure, the luminescent dyes 130 and 140 may convert a wavelength of light incident on the light-collecting device panel 100 and emit the light, but may not be limited thereto.

For example, the luminescent dyes 130 and 140 may be luminescent dyes selected from the group consisting of 9,10-bis(phenylethynyl)anthracene (BPEA), palladium(meso-tetraphenyl-tetrabenzoporphyrin) (PdTPBP), 5,12-bis(phenylethynyl)naphthacene, 9,10-diphenylanthracene, and combinations thereof, but may not be limited thereto. Herein, 9,10-bis(phenylethynyl)anthracene (BPEA) used as the luminescent dyes may emit green fluorescence, 5,12-bis(phenylethynyl)naphthacene may emit orange fluorescence, and 9,10-diphenylanthracene may emit blue fluorescence, but may not be limited thereto. Particularly, BPEA is a typical intramolecular charge transport compound composed of an electron-rich anthracene moiety and an electron-acceptor and emits light having a wavelength of about 520 nm and may have high fluorescent quantum efficiency. The luminescent dyes 130 and 140 may convert a wavelength through down-conversion and/or up-conversion (conversion to a higher frequency) and emit light in a wavelength range which can be absorbed by the dye contained in the photoelectrode, and, thus, the light absorption of the dye contained in the photoelectrode can be increased and the efficiency of the solar cell can be improved. For example, if incident light is red light, the luminescent dyes may perform up-conversion to emit blue light. Particularly, red light has a longer wavelength and lower energy than blue light. Therefore, when the luminescent dyes absorb red light and emit blue light with higher energy, the energy level of the emitted light increases, and, thus, up-conversion may occur.

In an embodiment of the present disclosure, the luminescent dyes 130 and 140 include a combination of two different luminescent dyes to perform both down-conversion and up-conversion. Thus, a luminescence amount or a luminescence intensity for a wavelength range which can be absorbed by the dye contained in the photoelectrode can be further increased and the efficiency of the solar cell can be improved. For example, the luminescent dyes 130 and 140 include a first luminescent dye and a second luminescent dye. The first luminescent dye emits light having a longer wavelength than emitted light through down-conversion and energy of light absorbed by the second luminescent dye (for example, the second luminescent dye functions as a light-absorbing dye that absorbs light having a longer wavelength than the light absorbed by the first luminescent dye and transfers energy of the absorbed light to the first luminescent dye) is transferred to the first luminescent dye and light having a shorter wavelength than the light absorbed by the second luminescent dye is emitted through wavelength conversion of the first luminescent dye (in this case, two photons in the light absorbed by the second luminescent dye are transferred to the first luminescent dye and light corresponding to one photon is emitted through wavelength conversion). Thus, a luminescence amount or a luminescence intensity for a wavelength range which can be absorbed by the dye contained in the photoelectrode can be further increased and the efficiency of the solar cell can be improved.

For example, if the luminescent dyes include a combination of BPEA and PdTPBP, the BPEA absorbs light of about 470 nm and emits light of about 520 nm through down-conversion of the BPEA luminescent dye and in addition, the PdTPBP absorbs light having a wavelength of about 630 nm and energy of the absorbed light is transferred to the BPEA luminescent dye present adjacent to the PdTPBP and light of about 520 nm is further emitted by the BPEA (in this case, light is emitted through up-conversion of the combination of PdTPBP/BPEA). The emitted light is propagated and absorbed by the dye contained in the photoelectrode, and, thus, the photoelectric conversion efficiency of the solar cell can be improved.

The luminescent dyes 130 and 140 dispersed in the polymer film 150 may each have both light absorption and light emission properties and may be present as a conjugated form in the polymer film 150. If the two luminescent dyes are present at the same time, one luminescent dye having relatively stronger light absorption properties functions as a light-absorbing dye and the other luminescent dye having relatively stronger light emission properties functions as a luminescent dye, and, thus, the light-absorbing dye absorbs incident light and the luminescent dye converts the incident light into light with a wavelength in a specific range to emit light/ fluorescence, but the present disclosure may not be limited thereto. For example, if sunlight including ultraviolet light, visible light, and infrared light is incident on the light-collecting device panel 100, the wavelength of the sunlight is converted into light in a wavelength range which can be absorbed by the dye contained in the photoelectrode of the dye-sensitized solar cell, by the above-described light absorption and light emission, and, thus, the efficiency of the solar cell can be improved.

In an embodiment of the present disclosure, the luminescent dyes 130 and 140 may be dispersed in a matrix of the polymer film 150, but may not be limited thereto. As described above, desirably, the luminescent dyes 130 and 140 may be present adjacent to each other to relatively function as a light-absorbing dye and a luminescent dye, respectively, or as a luminescent dye and a light-absorbing dye, respectively.

In an embodiment of the present disclosure, the polymer film 150 may include ethylene vinyl acetate (EVA), polyvinyl alcohol (PVA), polyvinyl chlorides (PVC), polyethylene terephthalates (PET), polyacrylates, polymethylmethacrylates (PMMA), polyurethanes, polycarbonates, polyethylenes, polypropylenes, polysiloxanes, cellulose acetate butyrates (CAB), polyisocyanates, polypropyleneoxides, hydroxyethyl acrylates, hydroxyethyl methacrylates, propyleneoxide monoacrylates, rubber-based compounds, or copolymers thereof, but may not be limited thereto. The polymer film 150 may contain a mixture of the luminescent dyes 130 and 140 and function as a matrix to support the luminescent dyes 130 and 140, but may not be limited thereto. The polymer film 150 has light transmitting properties, and any polymer film having a light transmittance that allows incident light to be easily absorbed and emitted by the luminescent dyes 130 and 140 can be used without limitation.

In an embodiment of the present disclosure, the polymer film in which the luminescent dyes are contained or dispersed may be prepared by mixing a solution containing the luminescent dyes with a solution containing the polymer, drying the mixed solution and then removing the solvents, but may not be limited thereto. The solvents contained in the solution containing the luminescent dyes and the solution containing the polymer, respectively, may be appropriately selected and used by those skilled in the art from solvents known to dissolve the luminescent dyes and the polymer, respectively. For example, the solvents contained in the solution containing the luminescent dyes and the solution containing the polymer, respectively, may include independently an aqueous solvent or an organic solvent. For example, the aqueous solvent may include water or alcohols and the organic solvent may include chloroform, ether, benzene, xylene, ketones, or aldehydes, but may not be limited thereto.

The content of the luminescent dyes contained in the polymer film may be regulated by regulating the concentration of the luminescent dyes in the solution containing the luminescent dyes, and, thus, the luminescence intensity can be regulated. For example, to achieve the optimum efficiency of the dye-sensitized solar cell, the concentrations of the luminescent dyes in the solution containing the luminescent dyes may be regulated to determine the optimum contents of the respective luminescent dyes contained in the polymer film and thus to optimize the luminescence intensity of the luminescent dyes.

Further, as described above, if the luminescent dye includes two luminescent dyes, the luminescence intensity can be regulated by controlling a ratio of the luminescent dyes. A molar ratio of the luminescent dye that absorbs light to the luminescent dye that converts a wavelength may be controlled to, for example, from about 1:100 to about 1:10, but may not be limited thereto. For example, the molar ratio of the luminescent dye that absorbs light to the luminescent dye that converts a wavelength may be controlled to about 1:10 to 100, about 1:10 to 90, about 1:10 to 80, about 1:10 to 70, about 1:10 to 60, about 1:10 to 50, about 1:10 to 40, about 1:10 to 30, or about 1:10 to 20, but may not be limited thereto.

In an embodiment of the present disclosure, light penetrating the light-collecting device panel 100 and absorbed and emitted by the luminescent dyes 130 and 140 is emitted by converting a wavelength of incident light. The emitted light may be totally reflected at an interface between the first transparent substrate 110 and the second transparent substrate 120 of the light-collecting device panel 100 due to a difference in refractive index between the transparent substrates and the air layer to be propagated to and collected at the the corners covering the light-collecting device panel 100, but may not be limited thereto. Sunlight incident on the solar cell can be distributed more uniformly through total reflection of the sunlight and the incident sunlight can transfer light energy without loss of energy until being emitted through a light-emitting surface in contact with the photoelectrode 210 of the frame 200.

In an embodiment of the present disclosure, the photoelectrode 210 may include an oxide of a transition metal selected from the group consisting of Ti, Cu, Zr, Sr, Zn, In, Ir, La, V, Mo, W, Sn, Nb, Y, Sc, Sm, Ga, and combinations thereof, but may not be limited thereto.

In an embodiment of the present disclosure, the photoelectrode 210 may be prepared by coating a transparent conductive metal oxide on a transparent conductive substrate, but may not be limited thereto. The transparent conductive substrate may be formed using those known in the art without limitation. The transparent conductive substrate may be prepared by depositing a transparent conductive oxide or a transparent conductive electrode containing a metal on a transparent substrate, but may not be limited thereto. The transparent substrate may be formed using any material having transparency that allows the incidence of external light without particular limitation and may be formed using, for example, a glass substrate or a transparent polymer substrate having flexibility. A material of the transparent polymer substrate which can be used for the transparent substrate may include, for example, polypropylene (PP), polyimide (PI), polyethylene terephthalate (PET), polyethylene naphthalate (PEN), polycarbonate (PC), triacetyl cellulose (TAC), or copolymers thereof, but may not be limited thereto.

The transparent conductive metal oxide may be formed including a conductive metal oxide selected from the group consisting of indium tin oxide (ITO), fluorine tin oxide (FTO), antimony tin oxide (ATO), zinc oxide (ZnO), tin oxide (SnO₂), ZnO—Ga₂O₃, ZnO—Al₂O₃, SnO₂—Sb₂O₃, and mixtures thereof. For example, the transparent conductive electrode may contain tin oxide (SnO₂) having excellent conductivity, transparency, and heat resistance or indium tin oxide (ITO) which is cheap in terms of cost, but may not be limited thereto. The transparent conductive electrode 100 may be used as a hierarchical porous photoelectrode by allowing light such as sunlight to be penetrated and incident thereinto.

The photoelectrode 210 may be formed using nanoparticles of the above-described metal oxide, e.g., semiconductive metal oxide, but may not be limited thereto. For example, nanoparticles of the above-described metal oxide are dispersed in an appropriate solvent and a dispersant is added if necessary and a dispersion containing the nanoparticles is coated and dried on a transparent conductive substrate to prepare a photoelectrode containing a porous metal oxide structure. Otherwise, a dispersion containing any other form of the above-described metal oxide may be coated and dried on a transparent conductive substrate to prepare a photoelectrode containing a porous metal oxide structure, but may not be limited thereto. The above-described coating method is not particularly limited and may include spin coating, dip coating, doctor blading, and the like, but may not be limited thereto. Then, a solution containing an appropriate dye is coated to the porous metal oxide structure to adsorb the dye thereon. In this way, a photoelectrode for dye-sensitized solar cell can be completed.

In an embodiment of the present disclosure, the frame may be a window frame shape having four corners, and the photoelectrodes 210 may be formed at the respective four corners in inner sides in contact with the light-collecting device panel, but may not be limited thereto. In an embodiment of the present disclosure, the photoelectrode 210 is surrounded by a counter electrode 230 and an electrolyte 220 may fill a gap between the photoelectrode 210 and the counter electrode 230, but may not be limited thereto.

In an embodiment of the present disclosure, a photosensitive dye may be further included on the photoelectrode 210. The photoelectrode in accordance with an embodiment of the present disclosure increases a specific surface area, resulting in an increase in the amount of dye adsorption. Therefore, if it is used as a photoelectrode for dye-sensitized solar cell, it can contribute to the increase in energy conversion efficiency of the solar cell. For example, in an embodiment of the present disclosure, a porous metal oxide structure may be immersed in a solution containing a photosensitive dye to adsorb and coat the photosensitive dye on inner and outer surfaces of the porous metal oxide structure. The photosensitive dye may be formed using those known in the art without particular limitation and may be formed using, for example, a dye in the form of metal composite including aluminum (Al), platinum (Pt), palladium (Pd), europium (Eu), lead (Pb), iridium (Ir), or ruthenium (Ru), but may not be limited thereto. Among these metals, ruthenium (Ru) is one of the platinum metals and can form various organic metal composites. Therefore, photosensitive dyes containing ruthenium (Ru) has been widely used. For example, Ru(etcbpy)₂(NCS)₂CH₃CN type is widely used. Herein, etc refers to (COOEt)₂ or (COOH)₂. Further, a dye containing an organic pigment may be used. Examples of the organic pigment may include rhodamine, riboflavin, triphenylmethane, coumarin, porphyrin, xanthine, and the like. These pigments may be used alone or as a mixture with a ruthenium (Ru) composite to improve the absorption of visible light having a long wavelength. Thus, it is possible to further improve the photoelectric conversion efficiency. When light is incident on and absorbed by the photosensitive dye, photoelectrons are generated. The generated photoelectrons are transferred to the transparent conductive substrate through the metal oxide structure.

Then, a solution containing an appropriate dye is coated on the porous metal oxide structure to adsorb the dye thereon. In this way, a photoelectrode for dye-sensitized solar cell can be completed.

For example, the porous metal oxide structure may be immersed in a solution containing a photosensitive dye to adsorb and coat the photosensitive dye on inner and outer surfaces, e.g., pore surfaces, of the porous metal oxide structure. The photosensitive dye may be formed using those known in the art without particular limitation and may be formed using, for example, a dye in the form of metal composite including aluminum (Al), platinum (Pt), palladium (Pd), europium (Eu), lead (Pb), iridium (Ir), or ruthenium (Ru), but may not be limited thereto. Among these metals, ruthenium (Ru) is one of the platinum metals and can form various organic metal composites. Therefore, photosensitive dyes containing ruthenium (Ru) has been widely used. For example, Ru(etcbpy)₂(NCS)₂CH₃CN type is widely used. Herein, etc refers to (COOEt)₂ or (COOH)₂ and also refers to a reactive group which can be combined with a porous membrane such as a surface of the porous metal oxide structure. Further, a dye containing an organic pigment may be used. Examples of the organic pigment may include rhodamine, riboflavin, triphenylmethane, coumarin, porphyrin, xanthine, and the like. These pigments may be used alone or as a mixture with a ruthenium (Ru) composite to improve the absorption of visible light having a long wavelength. Thus, it is possible to further improve the photoelectric conversion efficiency. When light is incident on and absorbed by the photosensitive dye, photoelectrons are generated. The generated photoelectrons are transferred to the transparent conductive substrate through the porous metal oxide structure.

Hereinafter, the counter electrode 230 included in the dye-sensitized solar cell in an embodiment of the present disclosure will be described in more detail.

Among the components of the dye-sensitized solar cell, the counter electrode 230 for the photoelectrode is disposed in parallel on a transparent conductive substrate, and a transparent electrode is formed on a substrate such as glass and a platinum layer is formed.

The transparent conductive substrate for the counter electrode may be formed by coating or depositing a transparent conductive electrode on a transparent substrate in the same manner as the transparent conductive substrate for the photoelectrode. Herein, the transparent substrate may be formed using any material having transparency that allows the incidence of external light without particular limitation and may be formed using, for example, a glass substrate or a transparent polymer substrate. A material of the transparent polymer substrate may include, for example, polypropylene (PP), polyimide (PI), polyethylene terephthalate (PET), polyethylene naphthalate (PEN), polycarbonate (PC), triacetyl cellulose (TAC), or copolymers thereof, but may not be limited thereto. Further, the transparent conductive electrode formed on the transparent substrate may contain a conductive metal oxide selected from the group consisting of indium tin oxide (ITO), fluorine tin oxide (FTO), antimony tin oxide (ATO), zinc oxide (ZnO), tin oxide (SnO₂), ZnO—Ga₂O₃, ZnO—Al₂O₃, SnO₂—Sb₂O₃, and mixtures thereof and may contain, for example, tin oxide (SnO₂) having excellent conductivity, transparency, and heat resistance or indium tin oxide (ITO) which is cheap in terms of cost, but may not be limited thereto. Herein, the reason for employing the transparent conductive substrate is to allow sunlight to be penetrated and incident thereinto. Further, in the present specification, the term “transparent” refers to not only the case where a material has a light transmittance of 100% but also the case where a material has a high light transmittance.

Meanwhile, the conductive layer included in the counter electrode functions to activate a redox couple and may contain a conductive material such as platinum (Pt), gold (Au), ruthenium (Ru), palladium (Pd), rhodium (Rh), iridium (Ir), osmium (Os), carbon (C), tungsten oxide (WO₃), titanium dioxide (TiO₂), or a conductive polymer, but may not be limited thereto. Since a higher reflectivity of the conductive layer formed on a surface of the counter electrode results in a higher efficiency, it is desirable to select a material with a high reflectivity.

Hereinafter, the electrolyte-containing layer 220 included in the dye-sensitized solar cell in an embodiment of the present disclosure will be described in more detail.

Among the components of the dye-sensitized solar cell, the electrolyte-containing layer 220 may be formed between the photoelectrode 210 and the counter electrode 230 by injecting a liquid containing an electrolyte (liquid electrolyte), a solid polymer electrolyte, or a gel-type polymer electrolyte, but may not be limited thereto. The electrolyte may contain, for example, iodide and functions to receive electrons from the counter electrode and transfer the electrons to dye molecules having lost electrons through redox reactions. The electrolyte may be uniformly dispersed in pores of the photoelectrode. The electrolyte may be formed as a liquid electrolyte and may contain a material as a iodide/triodide couple that functions to receive electrons from the counter electrode and transfer the electrons to the dye molecules through redox reactions, but may not be limited thereto. For example, a solution in which iodine (I₂) is dissolved in acetonitrile (CAN) may be used as the electrolyte, but the present disclosure may not be limited thereto. Any solution having a hole conducting function can be used without particular limitation. For example, a solution in which about 0.7 M 1-butyl-3-methylimidazolium iodide (BMII), about 0.03 M iodine (I₂), about 0.1 M guanidium thiocyanate (GSCN), and about 0.5 M 4-tert-buthylpyridine (4-TBP) are dissolved in a mixed solution of acetonitrile (CAN) and valeronitrile (VN) (at a volume ratio of 85:15) may be used as the electrolyte, but the present disclosure may not be limited thereto.

A sealing unit may be formed in the edges of the photoelectrode 210 and the counter electrode 230 to suppress leakage of the electrolyte included in the dye-sensitized solar cell. The sealing unit may contain a thermoplastic polymer material and may be hardened by heat or ultraviolet light, but may not be limited thereto. As a specific example, the sealing unit may contain an epoxy resin, but may not be limited thereto. For example, a polymer film having a thickness of several tens may be inserted as the sealing unit between the photoelectrode and the counter electrode to maintain a gap therebetween.

Meanwhile, electrolytes which can be used in a dye-sensitized solar cell can be classified into a liquid electrolyte, a gel-type electrolyte, and a solid electrolyte depending on the properties thereof. If a solar cell is manufactured using the above-described liquid electrolyte, the energy conversion efficiency is increased but a solvent included in the liquid electrolyte may be leaked or volatilized depending on an increase in external temperature and a sealing state of the solar cell, which may result in a decrease in life of the solar cell. In order to solve this problem, the electrolyte used in a dye-sensitized solar cell may include a member selected from the group consisting of a solid polymer electrolyte, a gel-type polymer electrolyte, and combinations thereof, but may not be limited thereto.

In an embodiment of the present disclosure, the gel-type electrolyte may contain, for example, an iodine-based redox couple (I₃⁻/I⁻), a low-volatile organic solvent, and a polymer material, but may not be limited thereto.

For example, an iodide for forming the iodine-based redox couple may include a member selected from the group consisting of n-methylimidazolium iodide, n-ethylimidazolium iodide, 1-benzyl-2-methyl imidazolium iodide, 1-ethyl-3-methyl imidazolium iodide, 1-butyl-3-methylimidazolium iodide, 1-methyl-3-propylimidazolium iodide, 1-methyl-3-isopropylimidazolium iodide, 1-methyl-3-butylimidazolium iodide, 1-methyl-3-isobutylimidazolium iodide, 1-methyl-3-s-butylimidazolium iodide, 1-methyl-3-pentylimidazolium iodide, 1-methyl-3-isopentylimidazolium iodide, 1-methyl-3-hexylimidazolium iodide, 1-methyl-3-isohexylimidazolium iodide, 1-methyl-3-ethylimidazolium iodide, 1,2-dimethyl-3-propylimidazolium iodide, 1-ethyl-3-isopropylimidazolium iodide, 1-propyl-3-propylimidazolium iodide, and combinations thereof, but may not be limited thereto.

For example, the low-volatile organic solvent may include a member selected from the group consisting of methoxypropionitrile, ethylenecarbonate, propylenecarbonate, diethylcarbonate, dimethylcarbonate, gamma-butyrolacton, dimethylformamide, and combinations thereof, but may not be limited thereto.

For example, the polymer material may be used to prepare a gel-type electrolyte by gelating a liquid electrolyte, but may not be limited thereto. For example, the polymer material as a conductive polymer can transfer electrons like conventional liquid electrolytes and solve the problem of leakage and volatilization of a dye-sensitized solar cell including a liquid electrolyte, but may not be limited thereto. For example, the polymer material contained in the gel-type electrolyte may include a member selected from the group consisting of polyethyleneoxide (PEO), poly(vinylidene fluoride-hexafluoropropylene) (PVdF-HFP), and combinations thereof, but may not be limited thereto.

For example, a ratio of iodide for forming the iodine-based redox couple and the polymer material may be from about 1:1 to about 1:3 based on weight %, but may not be limited thereto.

In an embodiment of the present disclosure, the electrolyte is present between the photoelectrode and the platinum-coated electrode and also present within pores of the photoelectrode. A liquid electrolyte having iodine-based redox couples may be used as the electrolyte. For example, a solution in which about 0.05 M lithium iodide, about 0.03 M iodine, about 0.7 M 1-butyl-3-methylimidazolium iodide (BMII), about 0.1 M guanidinium thiocyanate (GSCN), and about 0.5 M 4-tertbutylpyridine (TBP) are dissolved in acetonitrile (ACN) and valeronitrile (VN) may be used as the electrolyte. To suppress leakage of the electrolyte solution, Surlyn having a thickness of about 60 μm may be used, but the present disclosure may not be limited thereto.

In an embodiment of the present disclosure, the dye-sensitized solar cell may be a window-type, but may not be limited thereto. For example, the light-collecting device panel is used in a transparent part of a window, and, thus, it can be lighted. Therefore, the light-collecting device panel can be used in a building's windows and doors requiring transparency. Accordingly, the solar cell can be operated with sunlight incident on the windows and doors without additional facilities. Therefore, a high-efficiency solar cell can be provided as a simple device.

In an embodiment of the present disclosure, the dye-sensitized solar cell may be installed in a house, a building, an automobile, a ship, a roadside guard rail, or a soundproof wall, but may not be limited thereto.

Hereinafter, the dye-sensitized solar cell of the present disclosure will be explained in more detail with reference to Examples. However, the present disclosure is not limited thereto.

### MODE FOR CARRYING OUT THE INVENTION

### EXAMPLES

### Example 1

A dye-sensitized solar cell including a light-collecting device panel according to the present example was manufactured as follows. First, 9,10-bis(phenylethynyl)anthracene (BPEA) as a first luminescent dye and palladium(meso-tetraphenyl-tetrabenzoporphyrin) (PdTPBP) as a second luminescent dye were dispersed in chloroform and then added to and mixed with a polyurethane solution. Then, the polyurethane solution mixed with BPEA and PdTPBP was vortexed at room temperature and then rotary-evaporated at 40° C. to evaporate chloroform. Then, the solution from which chloroform was evaporated was dropped in two transparent glass substrates and hardened overnight to manufacture a light-collecting device panel.

The light-collecting device panel manufactured as described above was brought into contact with TiO₂ photoelectrodes (containing a D205 dye) formed at respective four inner corners of a frame and then fixed with tape. The four photoelectrodes were simultaneously brought into close contact with the light-collecting device panel in order for light emitted from the light-collecting device panel to be well absorbed by the photoelectrodes. As a result, a dye-sensitized solar cell including the light-collecting device panel was manufactured.

The luminescent dyes used in the sunlight-collecting device panel are 9,10-bis(phenylethynyl)anthracene (BPEA) and palladium(meso-tetraphenyl-tetrabenzoporphyrin) (PdTPBP). These two luminescent dyes each have both light absorption and light emission properties, and if the two dyes are present at the same time, they are also involved in light absorption/light emission wavelength conversion and convert light having a wavelength which cannot be absorbed by a typical dye-sensitized solar cell into light having a wavelength which can be absorbed by the solar cell.

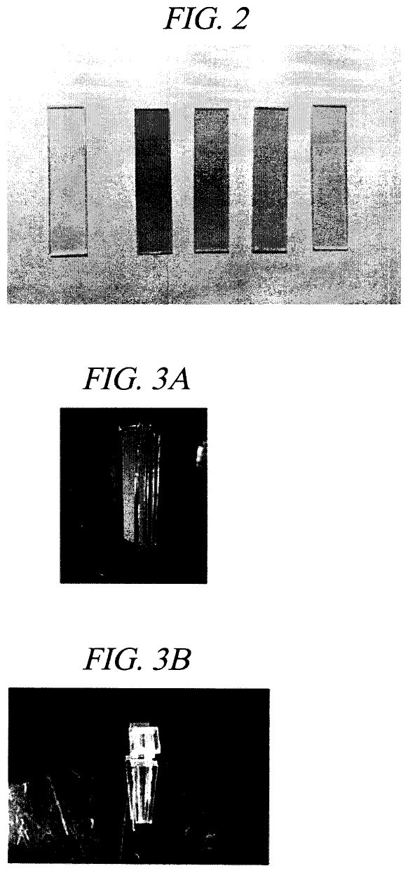

Photographs of the manufactured light-collecting device panel and the dye-sensitized solar cell including the light-collecting device panel are shown in FIG. 2 and FIG. 3, respectively.

Further, as a comparative example, a light-collecting device panel was manufactured using 9,10-bis(phenylethynyl)anthracene (BPEA) only as a luminescent dye.

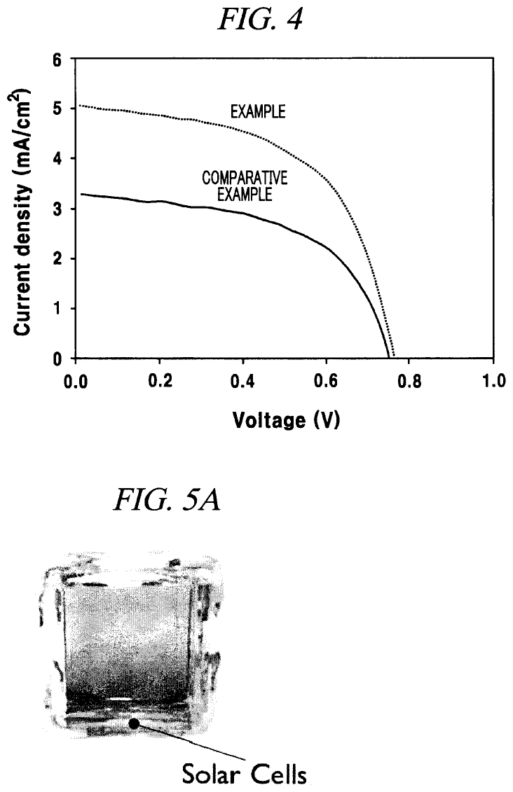

FIG. 4 is a graph showing current-voltage relationship measured from a dye-sensitized solar cell in accordance with the present example and the comparative example.

As shown in FIG. 4, in the comparative example including only the BPEA luminescent dye, BPEA absorbed light of 470 nm through down-conversion (conversion to a lower frequency) by the BPEA luminescent dye and emitted light of 520 nm and the emitted light was propagated and absorbed by the D205 dye of the photoelectrode with efficiency of 1.3%.

However, as shown in FIG. 4, in the present example including both PdTPBP and BPEA luminescent dyes, light was emitted through down-conversion from 470 nm to 520 nm by the BPEA luminescent dye and light having a wavelength of about 630 nm which cannot be absorbed by the D205 dye was absorbed by the PdTPBP, and, thus, energy of the absorbed light was transferred to the BPEA luminescent dye present adjacent to the PdTPBP and light of 520 nm was further emitted by the BPEA luminescent dye (in this case, light was emitted through up-conversion of the combination of PdTPBP/BPEA dyes). The emitted light was propagated and absorbed by the D205 dye of the photoelectrode with efficiency of 2.1%. Thus, the improvement in photoelectric conversion efficiency of a solar cell could be confirmed. Therefore, the usefulness of manufacturing a sunlight-collecting device containing a dye that enables wavelength conversion to a wavelength in a visible light range which can be absorbed by a solar cell and additional application to a solar cell can be expected.

Particularly, the efficiency of the dye-sensitized solar cell having four corners according to the present example can be assumed based on the efficiency confirmed from FIG. 4. If solar cells are installed on all of four sides of a sunlight-collecting device, the efficiency thereof can be expected to exceed that of a typical solar cell. Particularly, the window-type solar cell according to an example of the present disclosure uses a sunlight-collecting device panel and thus can provide the improved photoelectric conversion efficiency as compared with the case of using the comparative example. Also, reduction in cost of electrode materials and substrates required for a solar cell manufacturing process can be expected.

### Example 2

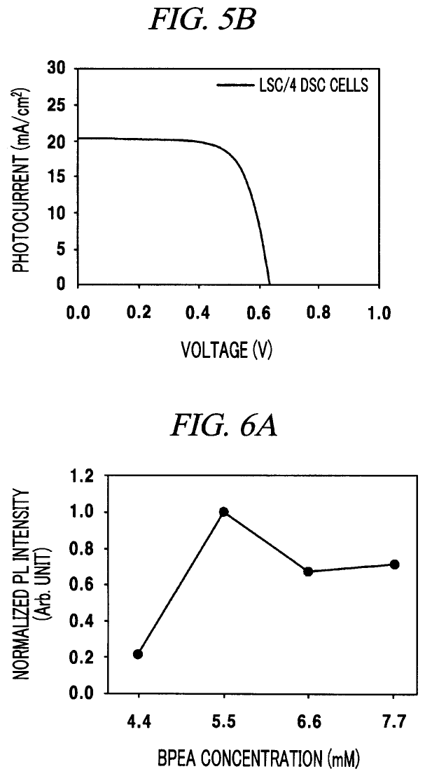

A dye-sensitized solar cell including a light-collecting device panel as shown in a photograph of FIG. 5A was manufactured by the method used in Example 1. The light-collecting device included a polyurethane polymer film containing a BPEA luminescent dye as a down-conversion luminescent dye and was composed of the polymer film and a glass panel covering the polymer film. Four dye-sensitized solar cells were connected to four corners of the light-collecting device. A dye-sensitized solar cell including a light-collecting device panel was finally implemented. As shown in a graph of FIG. 5B, the efficiency of the solar cell was measured as 9.1%.

### Example 3

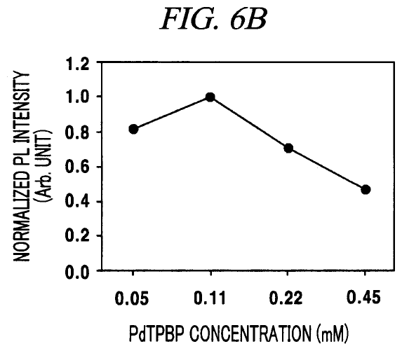

A dye-sensitized solar cell including a light-collecting device panel with a different kind and concentration of luminescent dye was manufactured by the method used in Example 1. The light-collecting device contained both BPEA and PdTPBP and was manufactured with various concentrations of these luminescent dyes. The luminescence efficiency of the luminescent dyes at each concentration was measured and a result thereof was as shown in FIG. 6. Specifically, the BPEA and PdTPBP luminescent dyes were dispersed in chloroform solvents, respectively, to prepare luminescent dye solutions. These solutions were mixed with a polyurethane solution and then, the solvent was evaporated with a rotary evaporator to prepare a polymer film in which the luminescent dyes were dispersed uniformly. The luminescence efficiency of the luminescent dyes may vary depending on the concentrations of the luminescent dyes contained in the polymer film. Under the test conditions of the present example, a polyurethane film (matrix) containing 5.5 mM BPEA and 0.11 mM PdTPBP showed the highest luminescence efficiency.

FIG. 6A shows a result of concertation optimization of a luminescent dye for the polymer film containing only BPEA, and FIG. 6B shows a result of concertation optimization of a light-absorbing dye by adding a PdTPBP dye into the polymer film having the optimized BPEA concentration as shown in FIG. 6A.

Under the test conditions of the present example, a polyurethane film (matrix) containing 5.5 mM BPEA and 0.11 mM PdTPBP showed the highest luminescence efficiency. That is, with 5.5 mM BPEA and 0.11 mM PdTPBP, light emitted after up-conversion had the highest intensity.

The above description of the present disclosure is provided for the purpose of illustration, and it would be understood by those skilled in the art that various changes and modifications may be made without changing technical conception and essential features of the present disclosure. Thus, it is clear that the above-described examples are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

### EXPLANATION OF REFERENCE NUMERALS

100: Light-collecting device panel
110: First transparent substrate
120: Second transparent substrate
130, 140: Luminescent dye
150: Polymer film
200: Frame
210: Photoelectrode
220: Electrolyte-containing layer
230: Counter electrode
300: Solar cell

We claim:

1. A dye-sensitized solar cell, comprising:
a light-collecting device panel disposed between a first transparent substrate and a second transparent substrate, including a polymer film containing a luminescent dye; and
a frame formed in contact with a corner of the light-collecting device panel, including a photoelectrode containing a dye.

2. The dye-sensitized solar cell of claim 1,
wherein the first transparent substrate and the second transparent substrate each independently include a glass or a transparent polymer.

3. The dye-sensitized solar cell of claim 1,
wherein the luminescent dye included in the polymer film comprises a luminescent dye selected from the group consisting of anthracene-based luminescent dyes, pyrene-based luminescent dyes, perylene-based luminescent dyes, fluorine-based luminescent dyes, and combinations thereof;
or selected from the group consisting of porphyrin-based luminescent dyes, benzoporphyrin-based luminescent dyes, metal-phthalocyanine-based luminescent dyes, polyimine-based luminescent dyes, and combinations thereof.

4. The dye-sensitized solar cell of claim 3,
wherein the luminescent dye included in the polymer film comprises one, or two or more different luminescent dyes.

5. The dye-sensitized solar cell of claim 1,
wherein the luminescent dye converts a wavelength of light incident on the light-collecting device panel to emit light with a wavelength in a visible light range.

6. The dye-sensitized solar cell of claim 1,
wherein the luminescent dye is dispersed in a matrix of the polymer film.

7. The dye-sensitized solar cell of claim 1,
wherein the polymer film comprises ethylene vinyl acetate (EVA), polyvinyl alcohol (PVA), polyvinyl chlorides (PVC), polyethylene terephthalates (PET), polyacrylates, polymethylmethacrylates (PMMA), polyurethanes, polycarbonates, polyethylenes, polypropylenes, polysiloxanes, cellulose acetate butyrates (CAB), polyisocyanates, polypropyleneoxides, hydroxyethyl acrylates, hydroxyethyl methacrylates, propyleneoxide monoacrylates, rubber-based compounds, or copolymers.

8. The dye-sensitized solar cell of claim 1,
wherein a light emitted by the luminescent dye contained in the light-collecting device panel is totally reflected at an interface between the light-collecting device panel and air to be collected at the corner of the light-collecting device panel.

9. The dye-sensitized solar cell of claim 1,
wherein the frame is a window frame shape having four corners, and the photoelectrodes are formed at the respective four corners in inner sides in contact with the light-collecting device panel.

10. The dye-sensitized solar cell of claim 1,
wherein the dye-sensitized solar cell is a window-type.

11. The dye-sensitized solar cell of claim 1,
wherein the dye-sensitized solar cell is installed in a house, a building, an automobile, a ship, a roadside guard rail, or a soundproof wall.
